(19) United States
(12) Patent Application Publication
(10) Pub. No.: US 2025/0110779 A1
(43) Pub. Date: Apr. 3, 2025

(54) AUDITABLE MECHANISM FOR INTERNAL SERVICES TO TRANSACT ON TENANT ENTITIES

(71) Applicant: Microsoft Technology Licensing, LLC, Redmond, WA (US)

(72) Inventors: Ram Kumar Donthula, Bothell, WA (US); Amber Bhargava, Issaquah, WA (US); Anand Rengasamy, Bothell, WA (US); Wilco Gerardus Bernardus Bauwer, Renton, WA (US); Grzegorz Andrzej Zygmunt, Sammamish, WA (US); Jagdish Singh, Kirkland, WA (US)

(21) Appl. No.: 18/477,312

(22) Filed: Sep. 28, 2023

(51) Int. Cl. G06F 9/50

(52) U.S. Cl. CPC G06F 9/5005

(57) ABSTRACT

Example aspects include techniques for providing an auditable mechanism for internal services to transact on tenant entities. These techniques may include receiving, from an internal service, by an assistant service, a service request to perform a cloud computing action over tenant data of a tenant of a cloud computing environment. In addition, the techniques may include identifying, by the assistant service, an existing principal of the assistant service within the tenant and possession of an existing permission associated with performing the cloud computing action within the tenant of the cloud computing environment. Further, the techniques may include performing the cloud computing action on behalf of the internal service based on identifying the existing principal and possession of the existing permission.

### BACKGROUND

Cloud technology offers a wide range of benefits, but it also comes with security risks and limitations that can hinder adoption and erode customer trust. For instance, internal services, such as support agents, may unintentionally or maliciously update customer account information or make unauthorized changes to customer account information without any visibility to customers. This lack of transparency and accountability can lead to security breaches and information leaks. Furthermore, some services continue to rely on full trust service-to-service calls, which also lack accountability and transparency. Such calls make called services vulnerable to security breaches, as an attack on one service can expose other connected services.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a method including: receiving, from an internal service, by an assistant service, a service request to perform a cloud computing action over tenant data of a tenant of a cloud computing environment; identifying, by the assistant service, an existing principal of the assistant service within the tenant and possession of an existing permission associated with performing the cloud computing action within the tenant of the cloud computing environment; and performing the cloud computing action on behalf of the internal service based on identifying the existing principal and possession of the existing permission.

In some aspects, the techniques described herein relate to a cloud computing platform device, including: one or more memories storing instructions; and one or more processors communicatively coupled with the one or more memories and configured to: receive, from an internal service, by an assistant service, a service request to perform a cloud computing action over tenant data of a tenant of a cloud computing environment; identify, by the assistant service, an existing principal of the assistant service within the tenant and possession of an existing permission associated with performing the cloud computing action within the tenant of the cloud computing environment; and perform the cloud computing action on behalf of the internal service based on identifying the existing principal and possession of the existing permission.

In some aspects, the techniques described herein relate to a non-transitory computer-readable device storing instructions thereon that, when executed by at least one computing device, causes the at least one computing device to perform operations including: receiving, from an internal service, by an assistant service, a service request to perform a cloud computing action over tenant data of a tenant of a cloud computing environment; identifying, by the assistant service, an existing principal of the assistant service within the tenant and possession of an existing permission associated with performing the cloud computing action within the tenant of the cloud computing environment; and performing the cloud computing action on behalf of the internal service based on identifying the existing principal and possession of the existing permission.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example of a cloud computing system, in accordance with some aspects of the present disclosure.

FIG. 2 is a flow diagram illustrating an example method for providing an auditable mechanism for internal services to transact on tenant entities, in accordance with some aspects of the present disclosure.

FIG. 3 is a block diagram illustrating an example of a hardware implementation for a cloud computing device(s), in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for providing an auditable mechanism for internal services to transact on tenant entities. In many systems, providing internal services (e.g., automated support agents) access to customer data can potentially lead to unauthorized changes to account information without the customer's permission. For example, some internal services rely on full trust service-to-service calls, where one service entirely trusts another service's identity and actions, without limitations or restrictions. However, this full trust approach raises security concerns due to its lack of accountability and transparency for end-users. This full trust approach also heightens the risk of security breaches, as an attack on one service may expose other connected services because of the unrestricted trust between them.

In accordance with some aspects of the present disclosure, a cloud security module is configured to provide secure and transparent access to tenant data by internal services. For example, the cloud security module may be configured to register an internal service to an assistant service, configure the assistant service to perform auditable cloud computing actions over tenant information in response to the registering, and perform auditable cloud computing actions in response to requests received by the assistant service from the internal service. By employing the assistant service to perform auditable cloud computing actions on behalf of internal services, the cloud security module provides improved transparency and accountability over conventional techniques.

### Illustrative Environment

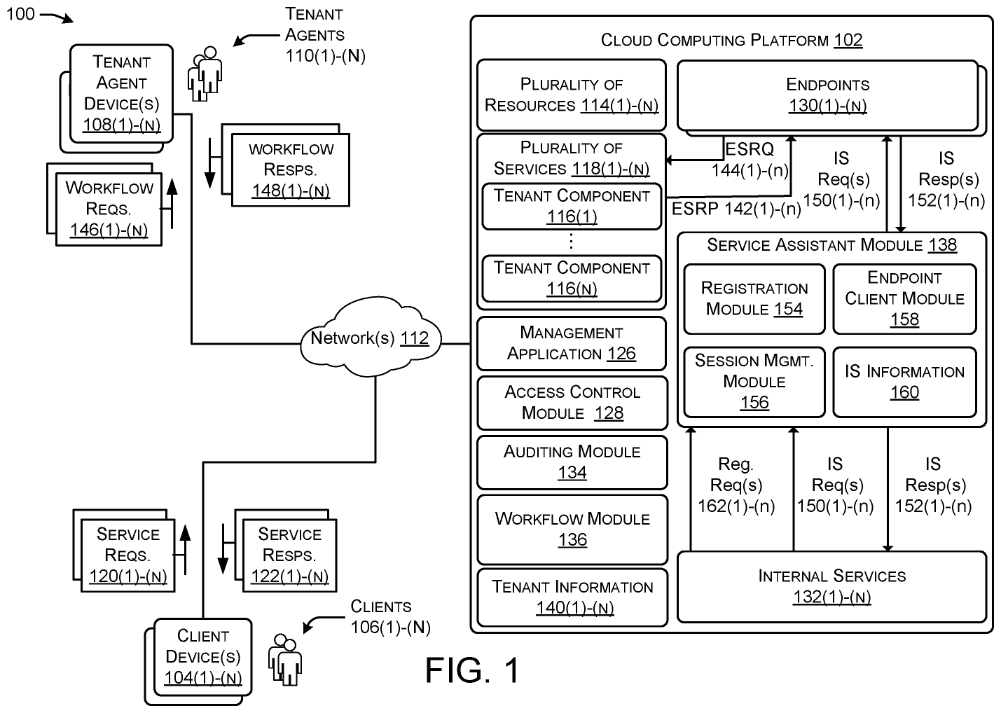

FIG. 1 is a diagram showing an example of a cloud computing system 100, in accordance with some aspects of the present disclosure. As illustrated in FIG. 1, the cloud computing system 100 may include a cloud computing platform 102, a plurality of client devices 104(1)-(n) associated with a plurality of clients 106(1)-(n), and a plurality of tenant agent devices 108(1)-(n) associated with a plurality of tenant agents 110(1)-(n). The cloud computing platform 102 may be a multi-tenant environment that provides the client devices 104(1)-(n) with access to applications, services, files, and/or data via one or more network(s) 112. In particular, the cloud computing platform 102 may implement a multi-tenant architecture wherein the resources 114(1)-(n) of the cloud computing platform 102 are shared among the tenants but individual data associated with each tenant is logically separated. As described herein, the tenants may be customers of the cloud computing platform 102. Additionally, a tenant agent 110 is an agent of a tenant of the cloud computing platform 102, and the tenant agent 110(1) has an account at the cloud computing platform 102. For example, a first tenant agent 108(1) is an engineer employed by a first tenant and the second tenant agent 108(2) is a billing coordinator employed by the first tenant. Further, the tenants may have relationships with the plurality of clients 106(1)-(n), and provide one or more tenant components 116(1)-(n) to the plurality of client devices 104(1)-(N) via the cloud computing platform 102.

As an example, the tenant component 116(1) may be a website, and the client device 104(1) may provide a client 106 access to the website. Further, the first tenant associated with the tenant component 116(1) may employ the cloud computing platform 102 to provide features of the website (i.e., tenant component 116(1)) to the client device 104(1). For instance, the tenant component 116(1) may configure the cloud computing platform 102 to transmit the content of the website to the client device 104(1) via the network 112. As another example, the tenant component 116(1) may be a database instance and the client device 104(1) may include a tenant application that utilizes the database instance via the network 112.

The network(s) 112 comprises any one or combination of multiple different types of networks, such as cellular networks, wireless networks, local area networks (LANs), wide area networks (WANs), personal area networks (PANs), the Internet, or any other type of network configured to communicate information between computing devices (e.g., the cloud computing platform 102, the client devices 104(1)-(N), the tenant agent devices 108(1)-(n)). Some examples of the client devices 104(1)-(n) and the tenant agent devices 108(1)-(n) include computing devices, smartphone devices, Internet of Things (IoT) devices, drones, robots, process automation equipment, sensors, control devices, vehicles, transportation equipment, tactile interaction equipment, virtual and augmented reality (VR and AR) devices, industrial machines, virtual machines, etc.

Further, each tenant component 116 is provided using one or more services 118 of the cloud computing platform 102. Some examples of the services 118(1)-(N) include infrastructure as a service (IaaS), platform as a service (PaaS), software as a service (SaaS), database as a service (DaaS), security as a service (SECaaS), big data as a service (BDaaS), a monitoring as a service (MaaS), logging as a service (LaaS), internet of things as a service (IOTaaS), identity as a service (IDaaS), analytics as a service (AaaS), function as a service (FaaS), and/or coding as a service (CaaS). Further, the resources 114(1)-(n) are reserved for use by the services 118(1)-(n). Some examples of the resources 114(1)-(n) include computing units, bandwidth, data storage, application gateways, software load balancers, memory, field programmable gate arrays (FPGAs), graphics processing units (GPUs), input-output (I/O) throughput, data/instruction cache, physical machines, virtual machines, clusters of virtual machines, clusters of physical machines, etc. Further, the client devices 104(1)-(n) may transmit service requests 120(1)-(n) and receive service responses 122(1)-(n) corresponding to the service requests 120(1)-(n) in order to access the tenant components 116(1)-(n).

As illustrated in FIG. 1, the cloud computing system 100 may also include a management application 126, an access control module 128, one or more endpoints 130(1)-(n), one or more internal services 132(1)-(n), an auditing module 134, a workflow module 136, a service assistant module 138, and tenant information 140(1)-(n). The management application 126 provides a web-based interface and/or an application programming interface (API) that allows tenant agents 110(1)-(n) to interact with and manage the plurality of resources 114(1)-(n) and/or the services 118(1)-(n). For example, in some aspects, the tenant agents 110(1)-(n) employ the management application 126 to create, configure, and manage the services 118(1)-(n), monitor and troubleshoot the performance and health of the resources 114(1)-(n), and configure access control and security settings to the plurality of resources 114(1)-(n) and the services 118(1)-(n) used by the tenant components 116(1)-(n). Further, in some aspects, the management application 126 enables the tenant agents 110(1)-(n) to manage billing and costs.

In some aspects, the access control module 128 manages various tasks to ensure security, privacy, and proper resource allocation among different tenant components 116. The access control module 128 handles authentication by verifying user identities before granting access to cloud resources. Additionally, the access control module 128 manages authorization by defining and enforcing permissions, privileges, and access levels for different tenant agent devices 108, tenant agents 110, and tenant components 116, and assigning roles based on the responsibilities of the tenant agent devices 108, the tenant agents 110, and the tenant components 116. For example, in some aspects, the access control module 128 determines that the requesting tenant agent 110(1) does not have permission to request performance of a cloud computing action. Further, the access control module 128 ensures isolation of the different tenant components 116 to maintain privacy and security. In some aspects, the access control module 128 isolates the tenant components 116(1)-(n) through techniques such as network segmentation, encryption, and containerization.

The one or more endpoints 130 provide access to the tenant information 140(1)-(n). In some aspects, each endpoint 130 is a data management resource (e.g., an application programming interface (API)) that allows tenant agents 110(1)-(n) to programmatically manage and monitor various types of tenant data and/or tenant information. For example, in some aspects, each endpoint provides functions for retrieving tenant records, updating tenant details, creating new entries, and deleting tenant data. In some aspects, a first endpoint is a billing information resource provider that allows tenant agents 110(1)-(n) to programmatically manage and monitor billing and cost management information. For example, the first endpoint 130(1) exposes API calls that cause the first endpoint 130(1) to provide tenant information, e.g., usage details, account balances, invoices, and other billing-related data. As illustrated in FIG. 1, in some aspects, an endpoint 130 receives an endpoint request 142 identifying a cloud computing action to be performed by the endpoint 130, and transmits an endpoint response 144 including the results of the cloud computing action. For instance, in some aspects, the endpoint request 142 is a query for tenant billing information, and the endpoint response 144 includes the tenant billing information. As another example, in some aspects, the endpoint request 142 is a request to update tenant information 140 of a tenant, and the endpoint response 144 indicates that the tenant information 140 was successfully updated by the endpoint 130.

The internal services 132(1)-(n) are cloud computing services and/or cloud computing processes that are not directly exposed to the client devices 104(1)-(n) and the tenant agent devices 108(1)-(n) but employed to assist and/or implement functions of the cloud computing platform 102. In some aspects, the internal services 132(1)-(n) are configured by an operator of the cloud computing platform 102 to monitor and log activity on the cloud computing platform 102. For example, in some aspects, the internal services 132(1)-(n) are configured by an operator of the cloud computing platform 102 to provide reliability and security functions to the resources 114(1)-(n), the tenant components 16(1)-(n), and the services 118.

The auditing module 134 monitors and audits activity and resource usage on the cloud computing platform 102. In some aspects, the auditing module 134 detects potential security breaches, unauthorized access, or misuse of resources. Further, in some aspects, the auditing module 134 maintains logs of user actions for auditing purposes and ensuring compliance with relevant regulations and policies. For example, in some aspects, the auditing module 134 generates log information in response to a service request 120 or an endpoint request 142.

The workflow module 136 performs cloud computing actions based on tenant agent approval. For example, as illustrated in FIG. 1, in some aspects, the workflow module 136 transmits workflow requests 146(1)-(n) to the tenant agent devices 108(1)-(n) and receives workflow responses 148(1)-(n) indicating whether the tenants 110(1)-(n) approve of the cloud computing action proposed in the corresponding workflow request 146. For example, in some aspects, a workflow module 136 transmits a workflow request 146(1) requests approval to update an account setting of the tenant component 116(1) managed by the tenant agent 110(1), and receives a workflow response 148(1) from the tenant agent device 108(1) indicating that the tenant agent 110(1) approves of the update to the account setting of the tenant component 116(1).

The service assistant module 138 manages access by the internal services 132(1)-(n) to the endpoints 130(1)-(n). Traditionally, in some cloud environments, internal services are permitted to perform cloud computing actions over tenant data and information with unrestricted permissions and/or without corresponding logging of the performance of the cloud computing actions by internal services, thereby permitting insecure access to tenant information while failing to generate a record of activity over tenant information in accordance with best security practices and regulatory requirements. For example, the service assistant module 138 receives internal service requests 150(1)-(n) from the internal services 132(1)-(n), manages execution of internal service requests 150(1)-(n) by the endpoints 130(1)-(n) when authorized, and transmits internal service responses 152(1)-(n) received from the endpoints 130(1)-(n) to the internal services 132(1)-(n).

The service assistant module 138 includes a registration module 154, a session management module 156, an endpoint client module 158, and internal service information 160. The registration module 154 registers the internal services 132(1)-(n) at the service assistant module 138 to access the endpoints 130(1)-(n). For example, the registration module 154 receives a registration request 162(1) from an internal service 132 to access tenant information 140(1) of a particular tenant via a first endpoint 130(1), and determines whether the internal service 132 is approved to employ the service assistant module 138. In some aspects, if the internal service 132 is approved to use the service assistant module 138, the registration module 154 registers the internal service 132 with the session management module 156. In some other aspects, the registration module 154 registers the internal service 132 with the session management module 156 based on the internal service 132 being approved to use the service assistant module 138 and the contents of the registration request 162. As an example, in some aspects, a registration request 162 include a scope of the access to the tenant information 140(1) by the internal service 132(1), an intent of the access to the tenant information 140(1) by the internal service 132(1), and a duration of the access to the tenant information 140(1) by the internal service 132(1). Further, in some aspects, the registration module 154 determines whether to register an internal service 132(1) based on the scope of the access to the tenant information 140(1), the intent of the access to the tenant information 140(1), and the duration of the access to the tenant information 140(1). Alternatively, in some aspects, if the internal service 132 is not approved to use the service assistant module 138, the registration module 154 will not register the internal service 132 with the session management module 156. As a result, this will prevent the unapproved internal services 132 from employing the service assistant module 138.

As used herein, in some aspects, “scope” refers to the level at which a permission is granted. For example, a permission can be granted at one of the following levels: a management group, subscription, resource group, or resource level. Further, the scope determines which resources are affected by a given role assignment or policy. For example, a role assignment at the subscription level will grant permissions to all resources within that subscription, whereas a role assignment at the resource group level will grant permissions only to resources within that specific resource group. As used herein, in some aspects, “intent” refers to a purpose or an objective behind a cloud computing action or access request. In some aspects, the intent identifies the reason why an internal service 132 requests access to a specific resource or set of resources. For example, an internal service 132(1) may need access to tenant information 140(1) to review billing information of the corresponding tenant. In some aspects, the registration module 154 evaluates the scope and intent to ensure that the principle of least privilege is followed, thereby reducing potential security risks. For example, if the internal service 132(1) endeavors to view billing information, the registration module 154 ensures that the scope does not exceed a viewing permission to the billing information within the tenant information 140(1).

In some examples, the registration module 154 employs the workflow module 136 to determine whether to register an internal service 132. For example, in some aspects, the registration module 154 employs the workflow module 136 to transmit a workflow request 146 requesting approval of registration of the internal service 132(1) to a tenant agent device 108, and the registration module 154 registers the internal service 132(1) based on receipt of a workflow response 148 from the tenant agent device 108 approving registration of the internal service 132(1).

The session management module 156 manages access sessions for the registered internal services 132 during which the internal services are permitted to leverage the service assistant module. For example, in some examples, the session management module 156 generates a session for an internal service 132(1), and provides access to particular tenant information 140(1) via specific endpoint 130(1) associated with the session while the session is active. Further, in some aspects, the session management module 156 terminates the session based upon a predefined amount of time elapsing and/or servicing a predefined number of internal service requests 150 via the session.

In some aspects, the session management module 156 initiates a session for an internal service 132(1) in response to the registration module 154 determining to register the internal service 132(1) to access tenant information 140(1) for a particular tenant. Further, in some aspects, the session management module 156 initiates the session by generating an instance of the service assistant module 138 within the tenant component 116(1) of the tenant, and causing assignment of a permission permitting access to the tenant information 140(1) to the service assistant module 138. Further, in some aspects, the session management module 156 determines the attributes of the permission based on the registration request 162, e.g., the scope of the access to the tenant information 140(1), the intent of the access to the tenant information 140(1), and the duration of the access to the tenant information 140(1). In some aspects, the permission is a role-based access control (RBAC) role, and the session management module 156 requests that the access control module 128 assign the role to the service assistant module 138. In addition, in some aspects, the session management module 156 or the access control module 128 generates a custom role that provides the least privilege required by the internal service 132(1) to access the tenant information 140(1) based on the scope of the access to the tenant information 140(1), the intent of the access to the tenant information 140(1), and the duration of the access to the tenant information 140(1), and the access control module 128 assigns the custom role to the session management module 156. For example, in some aspects, the session management module 156 determines that an internal service 132(1) requires access to tenant information 140(1) for twenty-four hours based upon the duration provided in the registration request 162, and requests that the access control module 128 assign a role to the service assistant module 138 that expires after twenty-four hours. Further, in some aspects, the service assistant module 138 stores the role and/or other information representing the initiation of a session within the internal service information 160.

In some aspects, the session management module 156 determines whether an internal service 132(1) has an existing session associated with particular tenant information 140(1) and/or a particular endpoint 130. For example, in response to receipt of an internal service request 150(1) from the internal service 132(1) for particular tenant information 140(1), the session management module 156 determines whether an internal service 132(1) has an existing session for the tenant information 140(1). If the session management module 156 determines that the internal service 132(1) has an existing session for the tenant information 140(1), the endpoint client module 158 transmits the internal service request 150(1) to the endpoint 130(1) associated with the session. If the session management module 156 determines that the internal service 132(1) does not have an existing session for the tenant information 140(1), the service assistant module 138 denies the internal service request 150(1). In some aspects, the session management module 156 determines whether an internal service 132(1) has an existing session for accessing particular tenant information based on the internal service information 160. For example, in some aspects, the session management module 156 determines that the internal service information 160 indicates that there is an instance of the service assistant module 138 executing within the tenant component 116(1) associated with the tenant in response to the registration request 162(1) received from internal service 132(1) and/or the internal service information 160 indicating assignment of a role to the service assistant module 138 in response to the registration request 162(1).

In some aspects, the session management module 156 determines whether to terminate an existing session. For example, in some aspects, the session management module 156 determines that a session duration configured during session initiation has expired and terminates the session. In some other aspects, the session management module 156 determines a predefined number of internal service requests 150 handled by the service assistant module 138 and the session management module 156 terminates the session. In some aspects, the session management module 156 terminates the session by deleting or invalidating the permission assigned to the service assistant module 138 during initialization of the session and terminating the instance of the service assistant module 138 executing within the tenant component (116) of the tenant associated with the tenant information 140(1).

The endpoint client module 158 transmits internal service requests 150(1)-(n) to the endpoints 130(1)-(n) on behalf of the internal services 132(1). For example, if the session management module 156 determines that an internal service 132(1) has an existing session in response to receipt of an internal service request 150(1) from the internal service 132(1), the endpoint client module 158 transmits the internal service request 150(1) to the endpoint 130(1) associated with session. Upon receipt of the internal service request 150(1), the endpoint 130(1) performs the cloud computing action identified within the internal service request 150(1) over the tenant information 140(1) based on the service assistant module 138 having an instance executing within the tenant component 116(1) and the service assistant module 138 having the permission assigned during initialization of the session. In some other aspects, the endpoint client module 158 generates an endpoint request 142(1) based on an internal service request 150(1) for the endpoint 130(1) and transmits the endpoint request 142(1) to the endpoint 130(1). Further, the endpoint client module 158 generates an internal service response 152(1) based on the endpoint response 144(1) received from the endpoint 130(1) and transmits the internal service response 152(1) to the internal service 132(1).

### Example Process

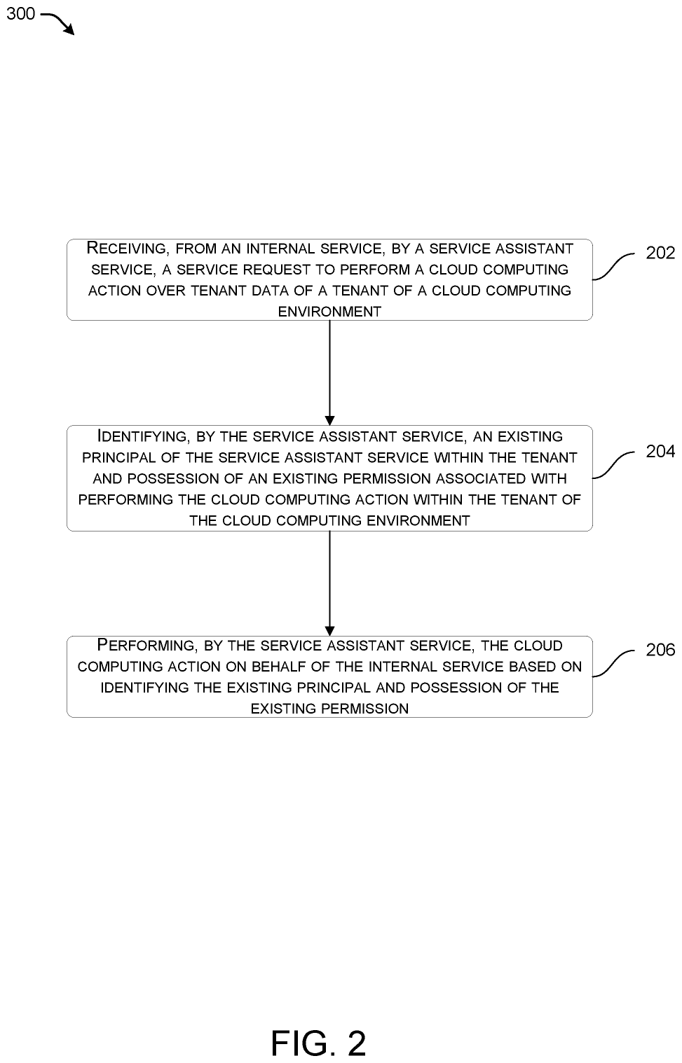

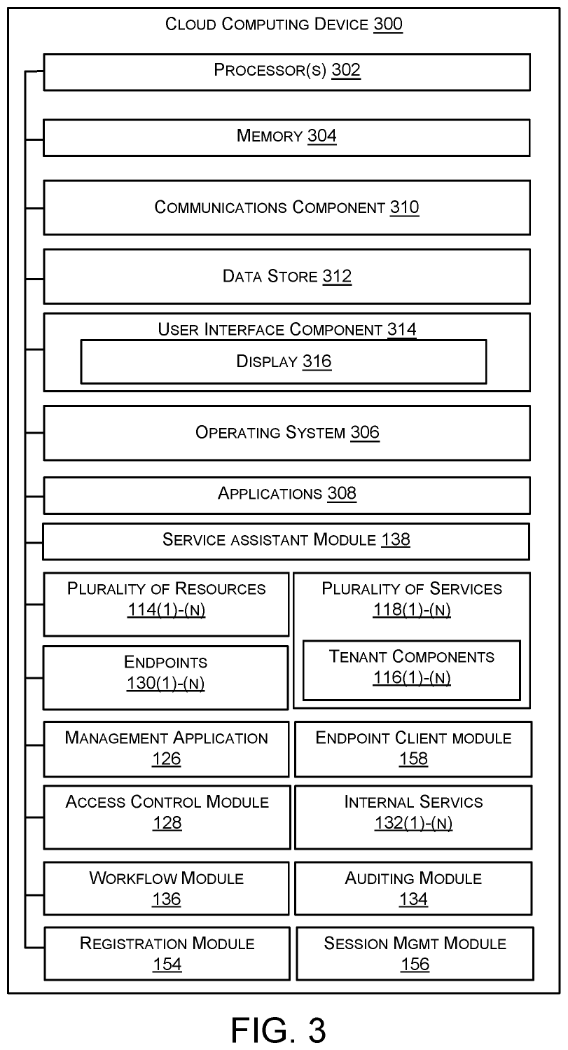

The processes described in FIG. 2 below are illustrated as a collection of blocks in a logical flow graph, which represent a sequence of operations that can be implemented in hardware, software, or a combination thereof. In the context of software, the blocks represent computer-executable instructions stored on one or more computer-readable media that, when executed by one or more processors, perform the recited operations. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. The operations described herein may, but need not, be implemented using the cloud computing platform 102. By way of example and not limitation, the method 200 is described in the context of FIGS. 1 and 3. For example, the operations may be performed by one or more of the plurality of services 118(1)-(n), the management application 126, the access control module 128, the one or more endpoints 130(1)-(n), the one or more internal services 132(1)-(n), the auditing module 134, the workflow module 136, the service assistant module 138, the registration module 154, the session management module 156, and the endpoint client module 158.

FIG. 2 is a flow diagram illustrating an example method 200 for providing an auditable mechanism for internal services to transact on tenant entities, in accordance with some aspects of the present disclosure.

At block 202, the method 200 includes receiving, from an internal service, by an assistant service, a service request to perform a cloud computing action over tenant data of a tenant of a cloud computing environment. For example, the service assistant module 138 receives an internal service request 150(1) from the internal service 132(1) for particular tenant information 140(1). Accordingly, the cloud computing platform 102, the computing device 300, and/or the processor 302 executing the service assistant module 138 may provide means for receiving, from an internal service, by an assistant service, a service request to perform a cloud computing action over tenant data of a tenant of a cloud computing environment.

At block 204, the method 200 includes identifying, by the assistant service, an existing principal of the assistant service within the tenant and possession of an existing permission associated with performing the cloud computing action within the tenant of the cloud computing environment. For example, the session management module 156 determines whether an internal service 132(1) has an existing session for the tenant information 140(1) in response to receipt of an internal service request 150(1) from the internal service 132(1). Accordingly, the cloud computing platform 102, the computing device 300, and/or the processor 302 executing the session management module 156 may provide means for identifying, by the assistant service, an existing principal of the assistant service within the tenant and possession of an existing permission associated with performing the cloud computing action within the tenant of the cloud computing environment.

At block 206, the method 200 includes performing the cloud computing action on behalf of the internal service based on identifying the existing principal and possession of the existing permission. For example, if the session management module 156 determines that the internal service 132(1) has an existing session for the tenant information 140(1), the endpoint client module 158 transmits the internal service request 150(1) to the endpoint 130(1) associated with the session. Further, upon receipt of the internal service request 150(1), the endpoint 130(1) performs a cloud computing action identified in the internal service request 150(1). In addition, in some aspects, the endpoint 130(1) transmits the internal service response 152(1) to the endpoint client module 158 in response to performance of the cloud computing action, and the endpoint client module 158 forwards the internal service response 152(1) to the internal service 132(1).

Accordingly, the cloud computing platform 102, the computing device 300, and/or the processor 302 executing the endpoint client module 158 and the endpoint 130 may provide means for includes performing the cloud computing action on behalf of the internal service based on identifying the existing principal and possession of the existing permission.

Additionally, or alternatively, in an aspect, the method 200 may further include receiving, from the internal service, by the assistant service, a registration request to access the tenant data of the tenant; generating, based on the registration request, by the assistant service, the existing principal for the assistant service within the tenant; and assigning the existing permission to the assistant service, the existing permission permitting performance of the cloud computing action. For example, the registration module 154 receives a registration request 162(1) from an internal service 132 to access tenant information 140(1) of a particular tenant via a first endpoint 130(1), and determines whether the internal service 132 is approved to employ the service assistant module 138. In some aspects, if the internal service 132 is approved to use the service assistant module 138, the registration module 154 registers the internal service 132 with the session management module 156. Accordingly, the cloud computing platform 102, the cloud computing device 300, and/or the processor 302 executing the registration module 154 and the session management module 156 may provide means for performing the action includes performing the action over a resource of the plurality of resources and not over other resources of the plurality of resources.

Additionally, or alternatively, in an aspect, the method 200 may further include wherein the registration request includes a scope of the access to the tenant data of the tenant, an intent of the access to the tenant data, and a duration of the access to the tenant data, and generating the existing principal includes: verifying at least one of the scope of the access to the tenant data of the tenant, the intent of the access to the tenant data, and the duration of the access to the tenant data; and generating the existing principal for the assistant service based upon the verifying. For example, in some aspects, a registration request 162 include a scope of the access to the tenant information 140(1) by the internal service 132(1), an intent of the access to the tenant information 140(1) by the internal service 132(1), and a duration of the access to the tenant information 140(1) by the internal service 132(1). Further, in some aspects, the registration module 154 determines whether to register an internal service 132(1) based on the scope of the access to the tenant information 140(1), the intent of the access to the tenant information 140(1), and the duration of the access to the tenant information 140(1). Accordingly, the cloud computing platform 102, the cloud computing device 300, and/or the processor 302 executing the registration module 154 may provide means for performing the action includes performing the action over a resource of the plurality of resources and not over other resources of the plurality of resources.

Additionally, or alternatively, in an aspect, the method 200 may further include wherein the registration request includes a scope of the access to the tenant data of the tenant, an intent of the access to the tenant data, and a duration of the access to the tenant data, and assigning the existing permission to the assistant service includes: generating a custom role based on at least one of at least one of the scope of the access to the tenant data of the tenant, the intent of the access to the tenant data, and the duration of the access to the tenant data; and assigning the custom role to the assistant service. For example, in some aspects, the session management module 156 or the access control module 128 determines a custom role that provides the least privilege required by the internal service 132(1) to access the tenant information 140(1) based on the scope of the access to the tenant information 140(1), the intent of the access to the tenant information 140(1), and the duration of the access to the tenant information 140(1), and the access control module 128 assigns the custom role to the session management module 156. Accordingly, the cloud computing platform 102, the cloud computing device 300, and/or the processor 302 executing the registration module 154, the session management module 156, and/or the access control module 128 may provide means for performing the action includes performing the action over a resource of the plurality of resources and not over other resources of the plurality of resources.

Additionally, or alternatively, in an aspect, the method 200 may further include wherein identifying the existing principal and the possession of the existing permission includes: identifying, by the assistant service, an existing session created by the assistant service for providing the internal service access to the tenant data. For example, in some aspects, the session management module 156 determines that the internal service information 160 indicates that there is an instance of the service assistant module 138 executing within the tenant component 116(1) associated with the tenant in response to the registration request 162(1) received from internal service 132(1) and/or the internal service information 160 indicating assignment of a role to the service assistant module 138 in response to the registration request 162(1). Accordingly, the cloud computing platform 102, the cloud computing device 300, and/or the processor 302 executing the session management module 156 may provide means for performing the action includes performing the action over a resource of the plurality of resources and not over other resources of the plurality of resources.

Additionally, or alternatively, in an aspect, the method 200 may further include wherein the service request is a first service request, the cloud computing action is a first cloud computing action, and further including: determining that predefined amount of time has elapsed since creation of the existing session; terminating, based upon determining the predefined amount of time has elapsed, the existing session by unassigning the existing permission and removing the existing principal from the tenant; receiving, from the internal service, by the assistant service, a second service request to perform a second cloud computing action over the tenant data of the tenant of the cloud computing environment; identifying, by the assistant service, that the existing session has been terminated; and denying performance, by the assistant service, of the second cloud computing action. For example, in some aspects, the session management module 156 determines that a session duration configured during session initiation has expired and terminates the session. In addition, a second internal service request 150(2) received from the internal service 121(1) may be denied based upon the termination of the session. Accordingly, the cloud computing platform 102, the cloud computing device 300, and/or the processor 302 executing the service assistant module 138 and the session management module 156 may provide means for performing the action includes performing the action over a resource of the plurality of resources and not over other resources of the plurality of resources.

Additionally, or alternatively, in an aspect, the method 200 may further include logging performance of the cloud computing action by the assistant service. For example, in some aspects, the auditing module 134 generates log information in response to performance of a cloud computing action by the endpoint 130(1) in response to the internal service request 150(1). Accordingly, the cloud computing platform 102, the cloud computing device 300, and/or the processor 302 executing the auditing module 134 may provide means for performing the action includes performing the action over a resource of the plurality of resources and not over other resources of the plurality of resources.

Additionally, or alternatively, in an aspect, the method 200 may further include determining that the internal service is approved to employ the assistant service, and wherein generating the existing principal includes: generating the existing principal based on determining that the internal service is approved to employ the assistant service. For example, in some aspects, the registration module 154 registers the internal service 132 with the session management module 156 based on the internal service 132 being approved to use the service assistant module 138 and the contents of the registration request 162. Accordingly, the cloud computing platform 102, the cloud computing device 300, and/or the processor 302 executing the registration module 154 may provide means for performing the action includes performing the action over a resource of the plurality of resources and not over other resources of the plurality of resources.

While the operations are described as being implemented by one or more computing devices, in other examples various systems of computing devices may be employed. For instance, a system of multiple devices may be used to perform any of the operations noted above in conjunction with each other.

### Illustrative Computing Device

Referring now to FIG. 3, an example of a cloud computing device(s) 300 (e.g., cloud computing platform 102). In one example, the cloud computing device(s) 300 includes the processor 302 for carrying out processing functions associated with one or more of components and functions described herein. The processor 302 can include a single or multiple set of processors or multi-core processors. Moreover, the processor 302 may be implemented as an integrated processing system and/or a distributed processing system. In an example, the processor 302 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 302 may include other processing components such as one or more arithmetic logic units (ALUs), registers, or control units.

In an example, the cloud computing device 300 also includes the memory 304 for storing instructions executable by the processor 302 for carrying out the functions described herein. The memory 304 may be configured for storing data and/or computer-executable instructions defining and/or associated with the operating system 306, the plurality of services 118(1)-(n), the management application 126, the access control module 128, the one or more endpoints 130(1)-(n), the one or more internal services 132(1)-(n), the auditing module 134, the workflow module 136, the service assistant module 138, the registration module 154, the session management module 156, and the endpoint client module 158, and the processor 302 may execute the operating system 306, the plurality of services 118(1)-(n), the management application 126, the access control module 128, the one or more endpoints 130(1)-(n), the one or more internal services 132(1)-(n), the auditing module 134, the workflow module 136, the service assistant module 138, the registration module 154, the session management module 156, and the endpoint client module 158. An example of memory 304 may include, but is not limited to, a type of memory usable by a computer, such as random-access memory (RAM), read only memory (ROM), tapes, magnetic discs, optical discs, volatile memory, non-volatile memory, and any combination thereof. In an example, the memory 304 may store local versions of applications being executed by processor 302.

The example cloud computing device 300 also includes a communications component 310 that provides for establishing and maintaining communications with one or more parties utilizing hardware, software, and services as described herein. The communications component 310 may carry communications between components on the cloud computing device 300, as well as between the cloud computing device 300 and external devices, such as devices located across a communications network and/or devices serially or locally connected to the cloud computing device 300. For example, the communications component 310 may include one or more buses, and may further include transmit chain components and receive chain components associated with a transmitter and receiver, respectively, operable for interfacing with external devices. In an implementation, for example, the communications component 310 may include a connection to communicatively couple the client devices 104(1)-(N) and the tenant agent devices 110(1)-(N) to the processor 302.

The example cloud computing device 300 also includes a data store 312, which may be any suitable combination of hardware and/or software, that provides for mass storage of information, databases, and programs employed in connection with implementations described herein. For example, the data store 312 may be a data repository for the operating system 306 and/or the applications 308.

The example cloud computing device 300 also includes a user interface component 314 operable to receive inputs from a user of the cloud computing device 300 and further operable to generate outputs for presentation to the user. The user interface component 314 may include one or more input devices, including but not limited to a keyboard, a number pad, a mouse, a touch-sensitive display (e.g., display 316), a digitizer, a navigation key, a function key, a microphone, a voice recognition component, any other mechanism capable of receiving an input from a user, or any combination thereof. Further, the user interface component 314 may include one or more output devices, including but not limited to a display (e.g., display 316), a speaker, a haptic feedback mechanism, a printer, any other mechanism capable of presenting an output to a user, or any combination thereof.

In an implementation, the user interface component 314 may transmit and/or receive messages corresponding to the operation of the operating system 306 and/or the applications 308. In addition, the processor 302 executes the operating system 306 and/or the applications 308, and the memory 304 or the data store 312 may store them.

Further, one or more of the subcomponents of the plurality of services 118(1)-(n), the management application 126, the access control module 128, the one or more endpoints 130(1)-(n), the one or more internal services 132(1)-(n), the auditing module 134, the workflow module 136, the service assistant module 138, the registration module 154, the session management module 156, and the endpoint client module 158, may be implemented in one or more of the processor 302, the applications 308, the operating system 306, and/or the user interface component 314 such that the subcomponents of the plurality of services 118(1)-(n), the management application 126, the access control module 128, the one or more endpoints 130(1)-(n), the one or more internal services 132(1)-(n), the auditing module 134, the workflow module 136, the service assistant module 138, the registration module 154, the session management module 156, and the endpoint client module 158, are spread out between the components/subcomponents of the cloud computing device 300.

As used in this application, the terms “component,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computer device and the computer device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various implementations or features may have been presented in terms of systems that may include a number of devices, components, modules, and the like. A person skilled in the art should understand and appreciate that the various systems may include additional devices, components, modules, etc. and/or may not include all of the devices, components, modules etc. discussed in connection with the figures. A combination of these approaches may also be used.

The various illustrative logics, logical blocks, and actions of methods described in connection with the embodiments disclosed herein may be implemented or performed with a specially-programmed one of a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computer devices, e.g., a combination of a DSP and a microprocessor, a plurality of microprocessors, one or more microprocessors in conjunction with a DSP core, or any other such configuration. Additionally, at least one processor may comprise one or more components operable to perform one or more of the steps and/or actions described above.

Further, the steps and/or actions of a method or procedure described in connection with the implementations disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some implementations, the processor and the storage medium may reside in an ASIC. Additionally, the ASIC may reside in a user terminal. In the alternative, the processor and the storage medium may reside as discrete components in a user terminal. Additionally, in some implementations, the steps and/or actions of a method or procedure may reside as one or any combination or set of codes and/or instructions on a machine readable medium and/or computer readable medium, which may be incorporated into a computer program product.

In one or more implementations, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While implementations of the present disclosure have been described in connection with examples thereof, it will be understood by those skilled in the art that variations and modifications of the implementations described above may be made without departing from the scope hereof. Other implementations will be apparent to those skilled in the art from a consideration of the specification or from a practice in accordance with examples disclosed herein.

### CONCLUSION

Clause 1. A method comprising: receiving, from an internal service, by an assistant service, a service request to perform a cloud computing action over tenant data of a tenant of a cloud computing environment; identifying, by the assistant service, an existing principal of the assistant service within the tenant and possession of an existing permission associated with performing the cloud computing action within the tenant of the cloud computing environment; and performing the cloud computing action on behalf of the internal service based on identifying the existing principal and possession of the existing permission.

Clause 2. The method of clause 1, further comprising: receiving, from the internal service, by the assistant service, a registration request to access the tenant data of the tenant; generating, based on the registration request, by the assistant service, the existing principal for the assistant service within the tenant; and assigning the existing permission to the assistant service, the existing permission permitting performance of the cloud computing action.

Clause 3. The method of clause 2, wherein the registration request includes a scope of the access to the tenant data of the tenant, an intent of the access to the tenant data, and a duration of the access to the tenant data, and generating the existing principal comprises: verifying at least one of the scope of the access to the tenant data of the tenant, the intent of the access to the tenant data, and the duration of the access to the tenant data; and generating the existing principal for the assistant service based upon the verifying.

Clause 4. The method of clause 2, wherein the registration request includes a scope of the access to the tenant data of the tenant, an intent of the access to the tenant data, and a duration of the access to the tenant data, and assigning the existing permission to the assistant service comprises: generating a custom role based on at least one of at least one of the scope of the access to the tenant data of the tenant, the intent of the access to the tenant data, and the duration of the access to the tenant data; and assigning the custom role to the assistant service.

Clause 5. The method of clause 1, wherein identifying the existing principal and the possession of the existing permission comprises: identifying, by the assistant service, an existing session created by the assistant service for providing the internal service access to the tenant data.

Clause 6. The method of clause 5, wherein the service request is a first service request, the cloud computing action is a first cloud computing action, and further comprising: determining that predefined amount of time has elapsed since creation of the existing session; terminating, based upon determining the predefined amount of time has elapsed, the existing session by unassigning the existing permission and removing the existing principal from the tenant; receiving, from the internal service, by the assistant service, a second service request to perform a second cloud computing action over the tenant data of the tenant of the cloud computing environment; identifying, by the assistant service, that the existing session has been terminated; and denying performance, by the assistant service, of the second cloud computing action.

Clause 7. The method of clause 1, further comprising logging performance of the cloud computing action by the assistant service.

Clause 8. The method of clause 1, further comprising determining that the internal service is approved to employ the assistant service, and wherein generating the existing principal comprises: generating the existing principal based on determining that the internal service is approved to employ the assistant service.

Clause 9. A cloud computing platform device, comprising: one or more memories storing instructions; and one or more processors communicatively coupled with the one or more memories and configured to execute the instructions to: receive, from an internal service, by an assistant service, a service request to perform a cloud computing action over tenant data of a tenant of a cloud computing environment; identify, by the assistant service, an existing principal of the assistant service within the tenant and possession of an existing permission associated with performing the cloud computing action within the tenant of the cloud computing environment; and perform the cloud computing action on behalf of the internal service based on identifying the existing principal and possession of the existing permission.

Clause 10. The cloud computing platform device of clause 9, wherein the one or more processors are configured to: receive, from the internal service, by the assistant service, a registration request to access the tenant data of the tenant; generate, based on the registration request, by the assistant service, the existing principal for the assistant service within the tenant; and assign the existing permission to the assistant service, the existing permission permitting performance of the cloud computing action.

Clause 11. The cloud computing platform device of clause 9, wherein to identify the existing principal and the possession of the existing permission, the one or more processors are configured to: identify, by the assistant service, an existing session created by the assistant service for providing the internal service access to the tenant data.

Clause 12. The cloud computing platform device of clause 11, wherein the service request is a first service request, the cloud computing action is a first cloud computing action, and the one or more processors are further configured to: determine that a predefined amount of time has elapsed since creation of the existing session; terminate, based upon determining the predefined amount of time has elapsed, the existing session by unassigning the existing permission and removing the existing principal from the tenant; receive, from the internal service, by the assistant service, a second service request to perform a second cloud computing action over the tenant data of the tenant of the cloud computing environment; identify, by the assistant service, that the existing session has been terminated; and deny performance, by the assistant service, of the second cloud computing action.

Clause 13. The cloud computing platform device of clause 9, wherein the one or more processors are configured to: log performance of the cloud computing action by the assistant service.

Clause 14. The cloud computing platform device of clause 9, wherein the one or more processors are further configured to determine that the internal service is approved to employ the assistant service, and to generate the existing principal, the one or more processors are further configured to: generate the existing principal based on determining that the internal service is approved to employ the assistant service.

Clause 15. A non-transitory computer-readable device storing instructions thereon that, when executed by at least one computing device, causes the at least one computing device to perform operations comprising: receiving, from an internal service, by an assistant service, a service request to perform a cloud computing action over tenant data of a tenant of a cloud computing environment; identifying, by the assistant service, an existing principal of the assistant service within the tenant and possession of an existing permission associated with performing the cloud computing action within the tenant of the cloud computing environment; and performing the cloud computing action on behalf of the internal service based on identifying the existing principal and possession of the existing permission.

Clause 16. The non-transitory computer-readable device of clause 15, wherein the operations further comprise: receiving, from the internal service, by the assistant service, a registration request to access the tenant data of the tenant; generating, based on the registration request, by the assistant service, the existing principal for the assistant service within the tenant; and assigning the existing permission to the assistant service, the existing permission permitting performance of the cloud computing action.

Clause 17. The non-transitory computer-readable device of clause 15, wherein identifying the existing principal and the possession of the existing permission comprises: identifying, by the assistant service, an existing session created by the assistant service for providing the internal service access to the tenant data.

Clause 18. The non-transitory computer-readable device of clause 17, wherein the service request is a first service request, the cloud computing action is a first cloud computing action, and further comprising: determining that a predefined amount of time has elapsed since creation of the existing session; terminating, based upon determining the predefined amount of time has elapsed, the existing session by unassigning the existing permission and removing the existing principal from the tenant; receiving, from the internal service, by the assistant service, a second service request to perform a second cloud computing action over the tenant data of the tenant of the cloud computing environment; identifying, by the assistant service, that the existing session has been terminated; and denying performance, by the assistant service, of the second cloud computing action.

Clause 19. The non-transitory computer-readable device of clause 15, wherein the operations further comprise logging performance of the cloud computing action by the assistant service.

Clause 20. The non-transitory computer-readable device of clause 15, wherein the operations further comprise determining that the internal service is approved to employ the assistant service, and wherein generating the existing principal comprises: generating the existing principal based on determining that the internal service is approved to employ the assistant service.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving, from an internal service, by an assistant service, a service request to perform a cloud computing action over tenant data of a tenant of a cloud computing environment;
identifying, by the assistant service, an existing principal of the assistant service within the tenant and possession of an existing permission associated with performing the cloud computing action within the tenant of the cloud computing environment; and
performing the cloud computing action on behalf of the internal service based on identifying the existing principal and possession of the existing permission.

2. The method of claim 1, further comprising:
receiving, from the internal service, by the assistant service, a registration request to access the tenant data of the tenant;
generating, based on the registration request, by the assistant service, the existing principal for the assistant service within the tenant; and
assigning the existing permission to the assistant service, the existing permission permitting performance of the cloud computing action.

3. The method of claim 2, wherein the registration request includes a scope of the access to the tenant data of the tenant, an intent of the access to the tenant data, and a duration of the access to the tenant data, and generating the existing principal comprises:
verifying at least one of the scope of the access to the tenant data of the tenant, the intent of the access to the tenant data, and the duration of the access to the tenant data; and
generating the existing principal for the assistant service based upon the verifying.

4. The method of claim 2, wherein the registration request includes a scope of the access to the tenant data of the tenant, an intent of the access to the tenant data, and a duration of the access to the tenant data, and assigning the existing permission to the assistant service comprises:
generating a custom role based on at least one of at least one of the scope of the access to the tenant data of the tenant, the intent of the access to the tenant data, and the duration of the access to the tenant data; and
assigning the custom role to the assistant service.

5. The method of claim 1, wherein identifying the existing principal and the possession of the existing permission comprises:
identifying, by the assistant service, an existing session created by the assistant service for providing the internal service access to the tenant data.

6. The method of claim 5, wherein the service request is a first service request, the cloud computing action is a first cloud computing action, and further comprising:
determining that predefined amount of time has elapsed since creation of the existing session;
terminating, based upon determining the predefined amount of time has elapsed, the existing session by unassigning the existing permission and removing the existing principal from the tenant;
receiving, from the internal service, by the assistant service, a second service request to perform a second cloud computing action over the tenant data of the tenant of the cloud computing environment;
identifying, by the assistant service, that the existing session has been terminated; and
denying performance, by the assistant service, of the second cloud computing action.

7. The method of claim 1, further comprising logging performance of the cloud computing action by the assistant service.

8. The method of claim 1, further comprising determining that the internal service is approved to employ the assistant service, and wherein generating the existing principal comprises:
generating the existing principal based on determining that the internal service is approved to employ the assistant service.

9. A cloud computing platform device, comprising:
one or more memories storing instructions; and
one or more processors communicatively coupled with the one or more memories and configured to execute the instructions to:
receive, from an internal service, by an assistant service, a service request to perform a cloud computing action over tenant data of a tenant of a cloud computing environment;
identify, by the assistant service, an existing principal of the assistant service within the tenant and possession of an existing permission associated with performing the cloud computing action within the tenant of the cloud computing environment; and
perform the cloud computing action on behalf of the internal service based on identifying the existing principal and possession of the existing permission.

10. The cloud computing platform device of claim 9, wherein the one or more processors are configured to:
receive, from the internal service, by the assistant service, a registration request to access the tenant data of the tenant;
generate, based on the registration request, by the assistant service, the existing principal for the assistant service within the tenant; and
assign the existing permission to the assistant service, the existing permission permitting performance of the cloud computing action.

11. The cloud computing platform device of claim 9, wherein to identify the existing principal and the possession of the existing permission, the one or more processors are configured to:
identify, by the assistant service, an existing session created by the assistant service for providing the internal service access to the tenant data.

12. The cloud computing platform device of claim 11, wherein the service request is a first service request, the cloud computing action is a first cloud computing action, and the one or more processors are further configured to:
determine that a predefined amount of time has elapsed since creation of the existing session;
terminate, based upon determining the predefined amount of time has elapsed, the existing session by unassigning the existing permission and removing the existing principal from the tenant;
receive, from the internal service, by the assistant service, a second service request to perform a second cloud computing action over the tenant data of the tenant of the cloud computing environment;
identify, by the assistant service, that the existing session has been terminated; and
deny performance, by the assistant service, of the second cloud computing action.

13. The cloud computing platform device of claim 9, wherein the one or more processors are configured to:
log performance of the cloud computing action by the assistant service.

14. The cloud computing platform device of claim 9, wherein the one or more processors are further configured to determine that the internal service is approved to employ the assistant service, and to generate the existing principal, the one or more processors are further configured to:
generate the existing principal based on determining that the internal service is approved to employ the assistant service.

15. A non-transitory computer-readable device storing instructions thereon that, when executed by at least one computing device, causes the at least one computing device to perform operations comprising:
receiving, from an internal service, by an assistant service, a service request to perform a cloud computing action over tenant data of a tenant of a cloud computing environment;
identifying, by the assistant service, an existing principal of the assistant service within the tenant and possession of an existing permission associated with performing the cloud computing action within the tenant of the cloud computing environment; and
performing the cloud computing action on behalf of the internal service based on identifying the existing principal and possession of the existing permission.

16. The non-transitory computer-readable device of claim 15, wherein the operations further comprise:
receiving, from the internal service, by the assistant service, a registration request to access the tenant data of the tenant;
generating, based on the registration request, by the assistant service, the existing principal for the assistant service within the tenant; and
assigning the existing permission to the assistant service, the existing permission permitting performance of the cloud computing action.

17. The non-transitory computer-readable device of claim 15, wherein identifying the existing principal and the possession of the existing permission comprises:
identifying, by the assistant service, an existing session created by the assistant service for providing the internal service access to the tenant data.

18. The non-transitory computer-readable device of claim 17, wherein the service request is a first service request, the cloud computing action is a first cloud computing action, and further comprising:
determining that a predefined amount of time has elapsed since creation of the existing session;
terminating, based upon determining the predefined amount of time has elapsed, the existing session by unassigning the existing permission and removing the existing principal from the tenant;
receiving, from the internal service, by the assistant service, a second service request to perform a second cloud computing action over the tenant data of the tenant of the cloud computing environment;
identifying, by the assistant service, that the existing session has been terminated; and
denying performance, by the assistant service, of the second cloud computing action.

19. The non-transitory computer-readable device of claim 15, wherein the operations further comprise logging performance of the cloud computing action by the assistant service.

20. The non-transitory computer-readable device of claim 15, wherein the operations further comprise determining that the internal service is approved to employ the assistant service, and wherein generating the existing principal comprises:
generating the existing principal based on determining that the internal service is approved to employ the assistant service.
